(19) United States
(12) Patent Application Publication
(10) Pub. No.: US 2013/0134819 A1
(43) Pub. Date: May 30, 2013

(54) RING SHAPED RUBBER MAGNET AND SPINDLE MOTOR HAVING THE SAME

(71) Applicants: Jin Sun Min, Gyunggi-do (KR); Byung Hoon Lee, Gyunggi-do (KR)

(72) Inventors: Jin Sun Min, Gyunggi-do (KR); Byung Hoon Lee, Gyunggi-do (KR)

(73) Assignee: SAMSUNG ELECTRO-MECHANICS CO., LTD., Gyunggi-do (KR)

(21) Appl. No.: 13/614,376

(22) Filed: Sep. 13, 2012

(30) Foreign Application Priority Data
Nov. 24, 2011 (KR) 10-2011-0123726

(51) Int. Cl. H02K 21/22

(52) U.S. Cl. 310/156.38

(57) ABSTRACT

Disclosed herein is a ring shaped rubber magnet for a spindle motor formed by coupling one surface and the other surface of a sheet shaped rubber magnet to each other, wherein one surface of the sheet shaped rubber magnet has an obtuse angle of 90 degrees or more at an edge of one end portion thereof and an acute angle of 90 degrees or less at an edge of the other end portion thereof, and the other surface of the sheet shaped rubber magnet has an acute angle of 90 degrees or less at an edge of one end portion thereof and an obtuse angle of 90 degrees or more at an edge of the other end portion thereof.

### CROSS REFERENCE TO RELATED APPLICATION

This application claims the benefit of Korean Patent Application No. 10-2011-0123726, filed on Nov. 24, 2011, entitled “Spindle Motor”, which is hereby incorporated by reference in its entirety into this application.

### BACKGROUND OF THE INVENTION

1. Technical Field

The present invention relates to a ring shaped rubber magnet and a spindle motor having the same.

2. Description of the Related Art

Generally, in a spindle motor, a shaft rotates while maintaining a predetermined contact section with a bearing, such that rotational characteristics may be maintained. Therefore, the spindle motor has been widely used as a unit for driving a recording medium requiring high speed rotation, such as a hard disk drive, an optical disk drive (ODD), or the like.

However, in the case of a driving magnet of a spindle motor according to the prior art, a circular magnet is manufactured by a molding process using a neodymium (Nd) material. In order to manufacture the magnet in this scheme, a rear earth material is used. However, due to difficulty in the distribution of the rare earth material in the market caused by the exclusive and limited supply of the rare earth material and a significant increase in a raw material price, a magnet that may be substituted for the magnet manufactured as described above has been demanded.

### SUMMARY OF THE INVENTION

The present invention has been made in an effort to provide a ring shaped rubber magnet including a sheet shaped rubber magnet having one surface and the other surface coupled to each other and including a coupling part formed by coupling one surface and the other surface of the sheet shaped rubber magnet and formed so as to increase an adhesion surface in a circumferential direction implemented in a ring shape, such that it may be implemented to have a more uniform ring shape, reduce touch sound between the ring shaped rubber magnet and a stator core in the case in which it is mounted in a spindle motor, and constantly output characteristics and signals of the motor at the coupling part, and a spindle motor having the same.

According to a preferred embodiment of the present invention, there is provided a ring shaped rubber magnet for a spindle motor formed by coupling one surface and the other surface of a sheet shaped rubber magnet to each other, wherein one surface of the sheet shaped rubber magnet has an obtuse angle of 90 degrees or more at an edge of one end portion thereof and an acute angle of 90 degrees or less at an edge of the other end portion thereof, and the other surface of the sheet shaped rubber magnet has an acute angle of 90 degrees or less at an edge of one end portion thereof and an obtuse angle of 90 degrees or more at an edge of the other end portion thereof.

One surface and the other surface of the sheet shaped rubber magnet may be coupled to each other to form a coupling part, wherein the coupling part is formed in a direction oblique to a circumferential direction implemented in a ring shape.

According to another preferred embodiment of the present invention, there is provided a ring shaped rubber magnet for a spindle motor by coupling one surface and the other surface of a sheet shaped rubber magnet to each other, wherein one surface of the sheet shaped rubber magnet includes repeatedly formed protrusion parts, and the other surface of the sheet shaped rubber magnet coupled to one surface thereof magnet includes repeatedly formed concave parts corresponding to the protrusion parts.

One surface and the other surface of the sheet shaped rubber magnet may be coupled to each other to form a coupling part, wherein the coupling part has triangular shapes repeatedly formed in a direction perpendicular to a circumferential direction implemented in a ring shape.

One surface and the other surface of the sheet shaped rubber magnet may be coupled to each other to form a coupling part, the coupling part having curve shapes repeatedly formed in a direction perpendicular to a circumferential direction implemented in a ring shape.

According to still another preferred embodiment of the present invention, there is provide a spindle motor including: a rotor part including a rotor case having a ring shaped rubber magnet and a shaft; and a stator part rotatably supporting the rotor part and including an armature facing the ring shaped rubber magnet.

The stator part may include: a bearing rotatably supporting the shaft; a bearing holder having the bearing inserted thereinto and supported thereby and including the armature forming electromagnetic force together with the magnet; a plate having the bearing holder vertically installed thereon; and a printed circuit board applying external power to the armature and coupled to the plate.

The stator part may further include: a stopper formed under the bearing in order to limit separation of the rotor part due to rotational force after the shaft is inserted into the bearing; a support supporting the shaft; and a thrust preventing direct friction between the support and the shaft and abrasion of the support and the shaft due to the direct friction, at the time of rotation of the shaft.

The rotor part may include: the shaft rotatably supported by the stator part; a rotor case fixed to an end portion of the shaft and including the magnet coupled to an inner portion thereof so as to correspond to the armature; and a clamp elastically supporting a recording medium positioned on the rotor case.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are, respectively, a development diagram and a coupling diagram schematically showing a ring shaped rubber magnet according to a first preferred embodiment of the present invention;

FIGS. 2A and 2B are, respectively, a development diagram and a coupling diagram schematically showing a ring shaped rubber magnet according to a second preferred embodiment of the present invention;

FIGS. 3A and 3B are, respectively, a development diagram and a coupling diagram schematically showing a ring shaped rubber magnet according to a third preferred embodiment of the present invention; and

FIG. 4 is a schematic cross-sectional view of a spindle motor having the ring shaped rubber magnet according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

Hereinafter, a ring shaped rubber magnet and a spindle motor having the same according to preferred embodiments of the present invention will be described in detail with reference to the accompanying drawings.

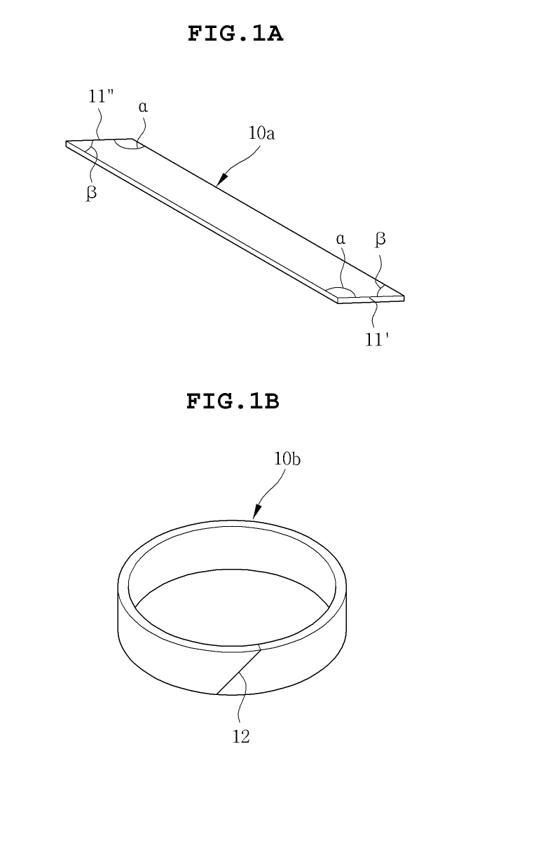

FIGS. 1A and 1B are, respectively, a development diagram and a coupling diagram schematically showing a ring shaped rubber magnet according to a first preferred embodiment of the present invention. As shown in FIGS. 1A and 1B, the rubber magnet 10a is manufactured in a sheet shape rather than a ring shape. Then, both end surfaces of the rubber magnet 10a are coupled to each other, such that a ring shaped rubber magnet 10b is formed. To this end, the rubber magnet 10a is formed of a diamond-shaped sheet having an acute angle and an obtuse angle.

More specifically, the rubber magnet 10a has one surface 11′ and the other surface 11″ coupled to each other, wherein one surface 11′ of the rubber magnet 10a has an obtuse angle (α) of 90 degrees or more at an edge of one end portion thereof and an acute angle (β) of 90 degrees or less at an edge of the other end portion thereof. Meanwhile, the other surface 11″ of the rubber magnet 10a coupled to one surface 11 of the rubber magnet 10a has an acute angle (β) of 90 degrees or less at an edge of one end portion thereof and an obtuse angle (α) of 90 degrees or more at an edge of the other end portion thereof.

One surface 11′ and the other surface 11″ of the rubber magnet 10a configured as described above are coupled to each other, such that the ring shaped rubber magnet 10b shown in FIG. 1B is formed. In addition, the ring shaped rubber magnet 11b is provided with a coupling part 12 at which one surface 11′ and the other surface 11″ of the rubber magnet 10a shown in FIG. 1A are coupled to each other.

Through the above-mentioned configuration, the ring shaped rubber magnet 10b according to the first embodiment of the present invention includes the coupling part 12 formed in a direction oblique to a circumferential direction implemented in a ring shape rather than a direction perpendicular to the circumferential direction to have an increased adhesion surface, such that it may be implemented to have a more uniform ring shape and productivity and a yield may be improved to secure a competitive price. Further, in the case in which the ring shaped rubber magnet 10b is mounted in a spindle motor, touch sound between the ring shape magnet 10b and a core may be reduced and characteristics and signals of the motor may be constantly output at the coupling part.

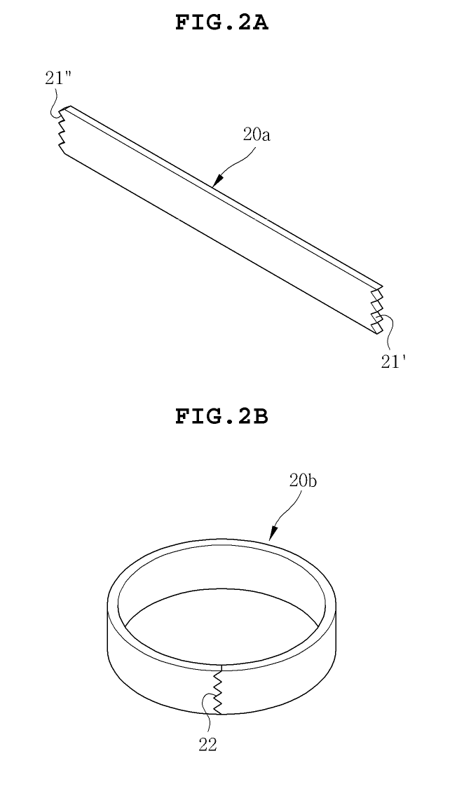

FIGS. 2A and 2B are, respectively, a development diagram and a coupling diagram schematically showing a ring shaped rubber magnet according to a second preferred embodiment of the present invention. As shown in FIGS. 2A and 2B, the ring shaped rubber magnet according to the second preferred embodiment of the present invention is different only in a shape of a coupling part from the ring shaped rubber magnet according to the first preferred embodiment of the present invention.

More specifically, the rubber magnet 20a is manufactured in a sheet shape rather than a ring shape. Then, both end surfaces of the rubber magnet 20a are coupled to each other, such that a ring shaped rubber magnet 20b is formed.

In addition, the rubber magnet 20a has one surface 21′ and the other surface 21″ coupled to each other, wherein one surface 21′ of the rubber magnet 20a includes repeatedly formed convex parts and the other surface 21″ of the rubber magnet 20a coupled to one surface 21′ of the rubber magnet 20a includes repeatedly formed concave parts corresponding to the convex parts. Further, the convex part and the concave part have a triangular shape.

One surface 21′ and the other surface 21″ of the rubber magnet 20a configured as described above are coupled to each other, such that the ring shaped rubber magnet 20b as shown in FIG. 2B is formed. In addition, the ring shaped rubber magnet 20b is provided with a coupling part 22 at which one surface 20′ and the other surface 21′ of the rubber magnet 20a′ shown in FIG. 2A are coupled to each other.

Through the above-mentioned configuration, the ring shaped rubber magnet 20b according to the second embodiment of the present invention includes the coupling part 22 having a structure in which the convex parts and the concave parts are repeatedly coupled to each other in a direction perpendicular to a circumferential direction implemented in a ring shape to have an increased adhesion surface, such that it may be implemented to have a more uniform ring shape. Further, in the case in which the ring shaped rubber magnet 20b is mounted in the spindle motor, touch sound between the ring shaped rubber magnet 20b and a core may be reduced and characteristics and signals of the motor may be constantly output at the coupling part.

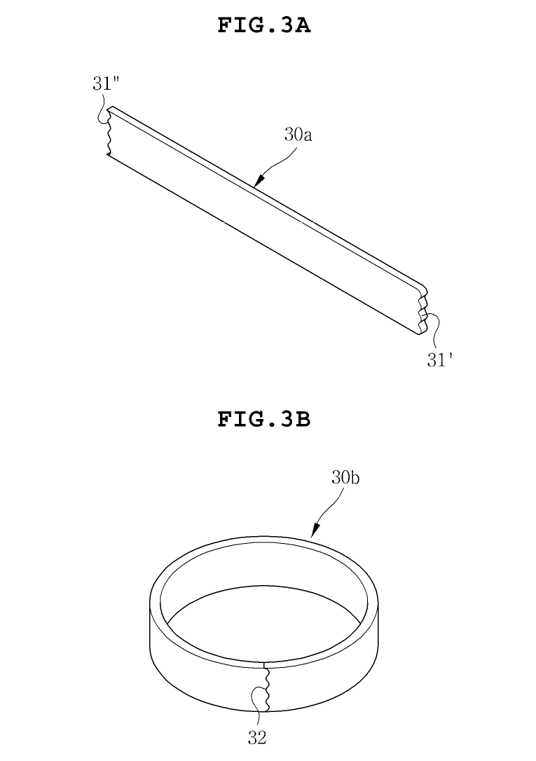

FIGS. 3A and 3B are, respectively, a development diagram and a coupling diagram schematically showing a ring shaped rubber magnet according to a third preferred embodiment of the present invention. As shown in FIGS. 3A and 3B, the ring shaped rubber magnet according to the third preferred embodiment of the present invention is different only in a shape of a coupling part from the ring shaped rubber magnet according to the first preferred embodiment of the present invention.

More specifically, the rubber magnet 30a is manufactured in a sheet shape rather than a ring. Then, both end surfaces of the rubber magnet 30a are coupled to each other, such that a ring shaped rubber magnet 30b is formed.

In addition, the rubber magnet 30a has one surface 31′ and the other surface 31″ coupled to each other, wherein one surface 31′ of the rubber magnet 30a includes repeatedly formed convex parts and the other surface 31″ of the rubber magnet 30a coupled to one surface 31′ of the rubber magnet 30a includes repeatedly formed concave parts corresponding to the convex parts. Further, the convex part and the concave part have a curved shape.

One surface 31′ and the other surface 31″ of the rubber magnet 30a configured as described above are coupled to each other, such that the ring shaped rubber magnet 30b as shown in FIG. 3B is formed. In addition, the ring shaped rubber magnet 30b is provided with a coupling part 32 at which one surface 30′ and the other surface 31″ of the rubber magnet 30a shown in FIG. 3A are coupled to each other.

Through the above-mentioned configuration, the ring shaped rubber magnet 30b according to the third embodiment of the present invention includes the coupling part 32 having a structure in which the curved convex parts and the curved concave parts are repeatedly coupled to each other in a direction perpendicular to a circumferential direction implemented in a ring shape to have an increased adhesion surface, such that it may be implemented to have a more uniform ring shape. Further, in the case in which the ring shaped rubber magnet 30b is mounted in the spindle motor, touch sound between the ring shaped rubber magnet 30b and a core may be reduced and characteristics and signals of the motor may be constantly output at the coupling part.

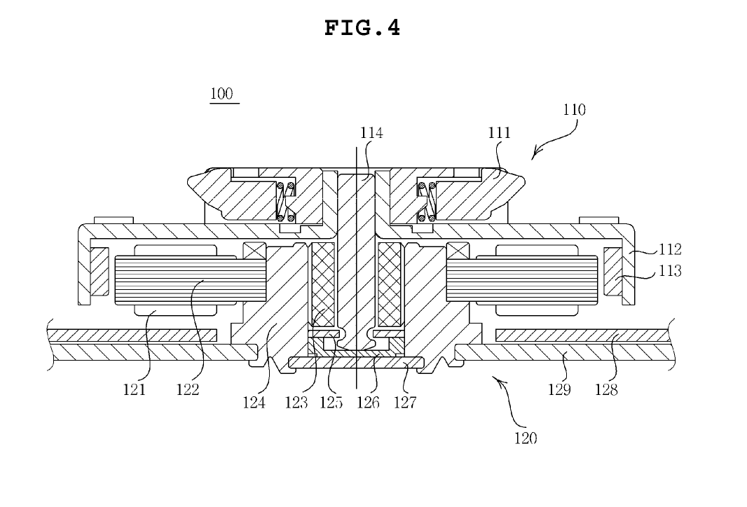

FIG. 4 is a schematic cross-sectional view of a spindle motor having the ring shaped rubber magnet according to the preferred embodiment of the present invention. As shown in FIG. 4, the spindle motor 100 is configured to include a rotor part 110 and a stator part 120. In addition, the rotor part 110 includes a clamp 111, a rotor case 112, a ring shaped rubber magnet 113, and a shaft 114; and the stator part 120 includes a coil 121, a core 122, a bearing 123, a bearing holder 124, a stopper 125, a thrust 126, a support 127, a printed circuit board 128, and a base 129.

More specifically, in the rotor part, the shaft 114 is rotatably supported by the bearing 123 of the stator part 120.

In addition, the rotor case 112 is fixed to an end portion of the shaft and includes the ring shaped rubber magnet 113 coupled to an inner portion thereof so as to correspond to an armature including the coil 121 and the core 122.

The ring shaped rubber magnet 113 may be any one of the ring shaped rubber magnets according to the preferred embodiments of the present invention shown in FIGS. 1A to 3B. Further, the clamp 111 elastically supports a recording medium positioned on the rotor case 112.

Furthermore, in the stator part, the bearing 123 rotatably supports the shaft 114, is formed in a cylindrical shape using a material such as a metal, or the like, and is fixed to an inner portion of the bearing holder 124 so that the center thereof coincides with a central axis of the shaft 114.

In addition, the bearing holder 124 has the bearing 123 inserted thereinto and supported thereby and includes the armature mounted at an outer portion thereof in order to be applied with external power to form electromagnetic force together with the magnet, wherein the armatures includes the coil 121 wound around the core 122.

The stopper 125 is formed under the bearing 123 in order to limit separation of the rotor part due to rotational force after the shaft 114 is inserted into the bearing 123.

In addition, the thrust 126 is to prevent direct friction between the support 127 and the shaft 114 and abrasion of the support 127 and the shaft 114 due to the direct friction, at the time of rotation of the shaft 114.

Further, the support 127 is to support the shaft 114, the stopper 125 and the thrust 126.

Further, the printed circuit board 128 applies the external power to the armature and is mounted on the base 129, and the base 129 has the bearing holder 124 vertically installed thereon.

In the spindle motor configured as described above, when current is applied to the armature 121 and 122, the shaft 114 and the rotor case 112 rotate together with each other by the electromagnetic force formed between the armature and the magnet 113.

Through the above-mentioned configuration, in the spindle motor having the ring shaped rubber magnet according to the preferred embodiment of the present invention, the touch sound between the magnet and the core may be reduced and characteristics and signals of the motor may be constantly output at the coupling part.

As set forth above, according to the preferred embodiment of the present invention, the ring shaped rubber magnet having an increased adhesion surface to be implemented in a more uniform ring shape, reducing the touch sound between the ring shaped rubber magnet and the stator core in the case in which it is mounted in a spindle motor, and constantly output the characteristics and the signals of the motor at the coupling part, and a spindle motor having the same may be provided.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A ring shaped rubber magnet for a spindle motor formed by coupling one surface and the other surface of a sheet shaped rubber magnet to each other, wherein one surface of the sheet shaped rubber magnet has an obtuse angle of 90 degrees or more at an edge of one end portion thereof and an acute angle of 90 degrees or less at an edge of the other end portion thereof, and the other surface of the sheet shaped rubber magnet has an acute angle of 90 degrees or less at an edge of one end portion thereof and an obtuse angle of 90 degrees or more at an edge of the other end portion thereof.

2. The ring shaped rubber magnet for a spindle motor as set forth in claim 1, wherein one surface and the other surface of the sheet shaped rubber magnet are coupled to each other to form a coupling part, the coupling part being formed in a direction oblique to a circumferential direction implemented in a ring shape.

3. A ring shaped rubber magnet for a spindle motor by coupling one surface and the other surface of a sheet shaped rubber magnet to each other, wherein one surface of the sheet shaped rubber magnet includes repeatedly formed protrusion parts, and the other surface of the sheet shaped rubber magnet coupled to one surface thereof magnet includes repeatedly formed concave parts corresponding to the protrusion parts.

4. The ring shaped rubber magnet as set forth in claim 3, wherein one surface and the other surface of the sheet shaped rubber magnet are coupled to each other to form a coupling part, the coupling part having triangular shapes repeatedly formed in a direction perpendicular to a circumferential direction implemented in a ring shape.

5. The ring shaped rubber magnet as set forth in claim 3, wherein one surface and the other surface of the sheet shaped rubber magnet are coupled to each other to form a coupling part, the coupling part having curve shapes repeatedly formed in a direction perpendicular to a circumferential direction implemented in a ring shape.

6. A spindle motor comprising:
a rotor part including a rotor case having a ring shaped rubber magnet and a shaft; and
a stator part rotatably supporting the rotor part and including an armature facing the ring shaped rubber magnet.

7. The spindle motor as set forth in claim 6, wherein the stator part includes:
a bearing rotatably supporting the shaft;
a bearing holder having the bearing inserted thereinto and supported thereby and including the armature forming electromagnetic force together with the magnet;
a plate having the bearing holder vertically installed thereon; and
a printed circuit board applying external power to the armature and coupled to the plate.

8. The spindle motor as set forth in claim 6, wherein the stator part further includes:
a stopper formed under the bearing in order to limit separation of the rotor part due to rotational force after the shaft is inserted into the bearing;
a support supporting the shaft; and
a thrust preventing direct friction between the support and the shaft and abrasion of the support and the shaft due to the direct friction, at the time of rotation of the shaft.

9. The spindle motor as set forth in claim 6, wherein the rotor part includes:
the shaft rotatably supported by the stator part;
a rotor case fixed to an end portion of the shaft and including the magnet coupled to an inner portion thereof so as to correspond to the armature; and
a clamp elastically supporting a recording medium positioned on the rotor case.
